(19) United States
(12) Patent Application Publication
(10) Pub. No.: US 2017/0132726 A1
(43) Pub. Date: May 11, 2017

(54) BEER KEG WITH USER LINK

(71) Applicant: Rehrig Pacific Company, Los Angeles, CA (US)

(72) Inventors: Kaley R. Parkinson, JR., Danville, CA (US); Nicholas J. Richardi, Manteca, CA (US)

(21) Appl. No.: 15/207,088

(22) Filed: Jul. 11, 2016

Related U.S. Application Data
(60) Provisional application No. 62/191,196, filed on Jul. 10, 2015.

(51) Int. Cl. G06Q 50/12; G06Q 10/08

(52) U.S. Cl. CPC G06Q 50/12; G06Q 10/087

(57) ABSTRACT

A beer keg or other beverage container is provided with a user link that can be linked with a mobile device. Each keg is identified by its user link. When the keg is filled, the fill date and information regarding the contents (e.g. specific flavor and production information) are associated with that keg on a server. The filled keg is shipped to a distributor, restaurant or bar. When the keg is tapped, the employee activates the link with a mobile device to access the stored information. The date, time and location of this activation is also provided to the server from the user's mobile device. Subsequently, when a potential customer is looking for a beer, he can use an app or data-providing service that will show him his preferred beer, the date and time the keg was tapped, optionally coupons or other incentives, and the location of the restaurant/bar.

### BACKGROUND

Bars and restaurants that serve beer regularly receive deliveries of kegs of beer. The kegs may be stored at the bar or restaurant until needed. When needed, the keg is tapped, but the restaurant or bar employees do not know how fresh the beer in the keg is. The customers are served beer from the tap; however, the customers do not know how fresh the beer is (e.g. when the keg was filled) or how long ago this keg was tapped.

### SUMMARY

A beer keg or other beverage container is provided with a user link, such as an NFC chip, RFID, Bluetooth, QR code, etc, that can be linked with a mobile device, such as a smartphone. Each keg is uniquely identified by its user link. When the keg is filled, the fill date (and optionally time) and information regarding the contents (e.g. specific flavor and production information) are associated with that keg on a server. The filled keg is shipped to a distributor, restaurant or bar. When the keg is tapped, the employee activates the link with a mobile device. This provides the employee with the stored information, to assure the employee regarding the freshness of the beer. The employee can also reorder more kegs via the mobile device, either through a web browser or dedicated app. The date, time and location of this activation is also provided to the server from the user's mobile device and stored on the server. Subsequently, when a potential customer is looking for a beer, he can use an app or data-providing service that will show him his preferred beer and the location of the restaurant or bar that tapped the keg. The app will also give him freshness data, including the date and time the keg with his preferred beer was tapped, optionally coupons or other incentives, and the location of the restaurant/bar.

### BRIEF DESCRIPTION OF THE DRAWINGS

FIG. 1 is a schematic of the container tracking system according to one embodiment.

FIG. 2 is a partial schematic of the servers of the tracking system.

### DETAILED DESCRIPTION OF A PREFERRED EMBODIMENT

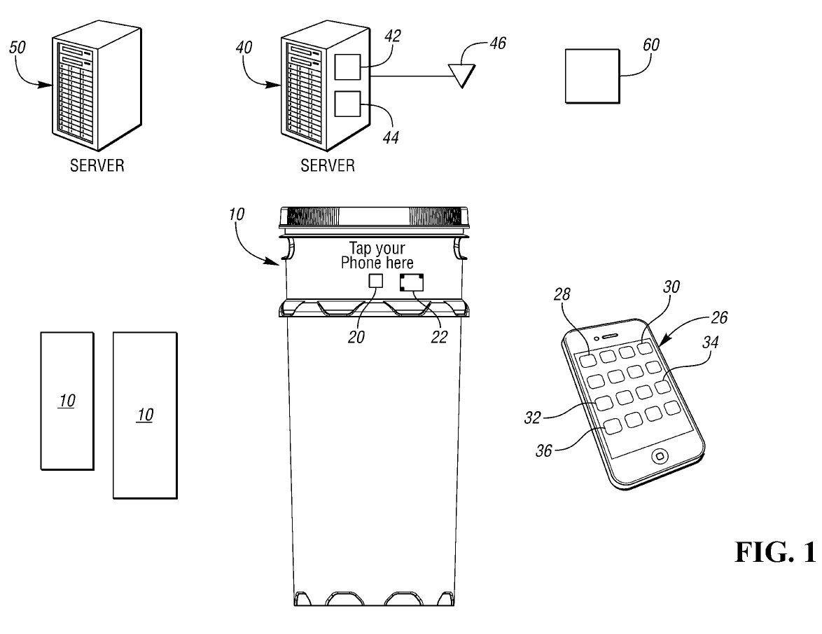

A first embodiment of a container tracking system relates to a keg 10 or other container for providing products to businesses, such as restaurants and bars, that are resold to their customers. The keg 10 shown as an example in FIG. 1 is for storing and dispensing beer (or other beverage). The keg 10 is preferably a plastic beer keg but could be a traditional metal beer keg. As is known, the keg 10 is one of thousands of kegs 10 that would be used by a distribution facility to deliver beer to restaurants, bars, etc.

The keg 10 includes at least one smartphone-readable user link, such as an NFC or RFID chip 20 and/or a QR code 22, secured thereto. In the example shown, the chip 20 and code 22 are placed on the sidewall 14, but other locations on the keg 10 are also possible. Other types of links and other protocols could also be used. The links uniquely identify each keg 10 (e.g. like a serial number).

A user mobile device or smartphone 26 includes hardware for reading one or more of the links on the keg 10, including a Bluetooth or NFC reader 28 and/or a camera 30 for reading the QR code 22. The smartphone 26 further includes a processor 32 with suitable electronic storage and programming for performing the functions described herein. The smartphone 26 further includes one or more wireless communication circuits 34 such as wifi, Bluetooth, cell-data, GSM, CDMA, etc. The smartphone 26 may also include a GPS receiver 36 or other location-determining hardware.

A server 40 (which could include more than one physical and/or virtual server) includes a processor 42 and electronic storage and is suitably programmed to perform the functions described herein. The server 40 receives communications from a plurality of smartphones such as smartphone 26, for example, via a cell tower 46 (or wireless access point) and via a network, such as the internet. The server 40 may selectively pass connections from smartphones 26 to a second server 50 or the server 40 may act as an intermediary between the smartphones 26 and the second server 50.

A second server 50 provides a web page and/or data over a wide-area network (such as the internet) to a smartphone app (which could be a web browser or a dedicated app). The data may relate to the product being sold in the container, such as coupons, games, contests, promotional videos, etc. The second server 50 may be operated by a manufacturer, distributor or licensor of the products in the keg 10.

The server 40 may be accessible by one or more computers 60 for monitoring the data collected on the server 40 and/or the data collected on server 50. The computers 60 provide access to the manufacturer, distributor or licensor.

In use, kegs 10 are loaded with beer (or other beverage). Each keg 10 is associated with its user link (e.g. NFC or RFID chip 20 and/or a QR code 22). Information regarding each keg 10 is stored on second server 50 (or alternatively, server 40). The information includes the beer production and specification data (including date of fill and freshness data). The kegs 10 are shipped to restaurants, bars, etc.

The keg customer (in this case, the owner or an employee of the restaurant, bar, etc, receiving the keg 10) can place his smartphone 26 near the chip 20 or use the camera 30 to read the QR Code. This directs the smartphone 26 over the wireless communication circuit 34 to connect (e.g. via the internet) to the server 40. The server 40 obtains user session data from the smartphone 26 and redirects the smartphone 26 to the second server 50.

The user session data received by the server 40 may include some or all of the following:

TABLE 1

| | |
|---|---|
| User Session Data Capture Record | QR Station Code Fields |

| | |
|---|---|
| Details | QR Station ID Code Field: |

| | |
|---|---|
| QR Station Code Fields | Capture this by using url parameters. Each |

| | |
|---|---|
| QR Station ID Code | group of QR station links to the same site but |
| QR Link URL | has a URL perimeter that needs to be passed |

| | |
|---|---|
| Geolocation Fields | through to the database. |

| | |
|---|---|
| GPS Geolocation | Example: |
| (Boolean) | http://qrdemo.com/program1?QRIDCODE=001 |
| [true if GPS sensor | would be saved as: 001 |
| used, false if IP address | http://qrdemo.com/program1?QRIDCODE=002 |
| Geolocation used] | would be saved as: 002 |
| Latitude | http://qrdemo.com/program1?QRIDCODE=003 |
| Longitude | would be saved as: 003 |
| Country | http://qrdemo.com/program1?QRIDCODE=004 |
| State | would be saved as: 004 |

| | |
|---|---|
| County | QR Link URL: |

| | |
|---|---|
| City | Capture the url of the link. |
| Zip Code | Example: |

| | |
|---|---|
| User Details Fields | http://qrdemo.com/program1?QRIDCODE=001 |

| | |
|---|---|
| Visitor IP Address | would be saved as: |
| Locale Language Code | http://qrdemo.com/program1 |
| Locale Country Code | http://qrdemo.com/program1?QRIDCODE=002 |
| Web Browser | would be saved as |
| Web Browser Version | http://qrdemo.com/program1 |
| OS Name | http://qrdemo.com/program2?QRIDCODE=003 |
| OS Version | would be saved as |
| Device Name | http://qrdemo.com/program2 |
| Device Version | http://qrdemo.com/program2?QRIDCODE=004 |
| Screen Resolution | would be saved as |

http://qrdemo.com/program2

User Details Fields

Can use several available methods such as
https://github.com/codejoust/session.js.

The server 40 obtains the unique identification of that keg 10 that was read by the user. The server 40 also obtains the location (from smartphone gps or Geolocation features). With just this information, a sampling of the locations over time of the inventory of thousands of kegs 10 is provided by the server 40. This provides the server 40 with the ability to provide asset management and tracking if desired. The server 40 can determine if kegs 10 are in locations that they were not expected to be. For example, the server 40 can determine if the kegs 10 are in stores that they are not supposed to be in, which may indicate that the producer (e.g. the bottler) is shipping outside the bottler's assigned geographic area. The server 40 can determine if the kegs 10 are in locations other than stores (e.g. possibly stolen). The server 40 also gathers data indicating how often the links are accessed.

The server 40 may then connect the smartphone 26 to the server 50. The GPS coordinates of the phone tie it to a location (e.g. a particular restaurant or bar) which is then pushed to a consumer-facing website that lists the “freshest” place to go get a particular beer flavor determined by sever 50 based upon the data.

The server 50 also provides access to webpages or access via smartphone apps to data on the server 50. The server 50 receives some or all of the user session data from server 40. The server 50 may selectively present data (e.g. webpage or other data) based upon the user session data. For example, the server 50 may select the data to present to the smartphone 26 based upon the location of the smartphone 26 (e.g. based upon city, state, region or country, or depending upon the particular store where the smartphone 26 accessed the link). The server 50 may present freshness data, authenticity, specials, recipes, drink concepts, etc. to the restaurant or bar owner.

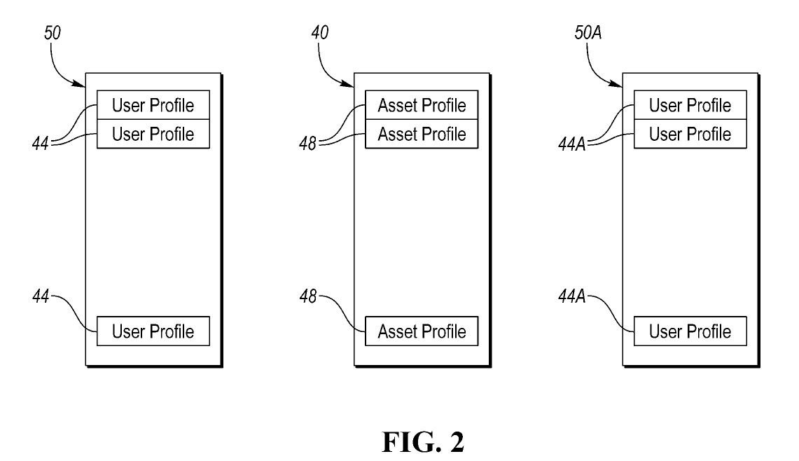

The smartphone 26 may have an app or web account that automatically logs the user into a personalized account or user profile on the server 50. As shown schematically in FIG. 2, the server 50 may store a plurality of user profiles 44. Each user profile 44 may contain more information about the keg customer (e.g. business name, type of business, location of business, etc) that is useful to the brewer (or other beverage supplier).

Again referring to FIG. 2, the server 40 may optionally include a record or asset profile 48 of each of the assets, such as each keg 10. Again, each keg 10 may be individually identifiable by the user link. Each asset profile 48 contains a record of every location and time/date that the keg 10 has been linked by a mobile device 26.

The server 40 may be programmed to redirect the user's mobile device 26 to the server 50 based upon the identification of the particular container 10 received by the server 40 from the user's mobile device 26. For example, the server 40 may be configured to track kegs 10 for a plurality of brewers and/or distributors (or other beverage suppliers). Depending upon the container identification received by the server 40, the server 40 may redirect the user's mobile device 26 to a third server 50A, associated with a different brewer or supplier, optionally with its own user profiles 44A. The third server 50A may provide different information, different ads, and track a different set of users.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method steps are for ease of reference in dependent claims and do not signify a particular sequence unless otherwise specified.

What is claimed is:

1) A method for tracking beer kegs including the steps of:
a) associating a user link with a beer keg;
b) filling the beer keg; and
c) in a computer, associating the user link with information specific to the beer keg.

2) The method of claim 1 wherein the user link includes an RF chip or an optical code.

3) The method of claim 2 wherein the user link includes NFC, RFID or a QR code.

4) The method of claim 3 wherein the information includes a date that the beer keg was filled.

5) The method of claim 4 wherein the information indicates contents of the beer keg.

6) The method of claim 5 further including the step of: d) receiving a communication from a smartphone indicating an activation of the user link.

7) The method of claim 6 further including the step of: e) storing a current date as the date that the beer keg was filled in the computer in response to said step d).

8) The method of claim 6 wherein said step d) further includes receiving a location where the activation of the user link occurred.

9) The method of claim 6 further including the step of: e) storing a current date as the date that the beer keg was tapped in the computer in response to said step d).

10) The method of claim 6 further including the step of: e) receiving a request from a smartphone, including a current geographic location of the smartphone; and f) responding to the request received in said step e) by sending to the smartphone at least some of the information specific to the beer keg.

11) The method of claim 10 wherein said step f) further includes the step of sending a current geographic location of the beer keg.

12) The method of claim 1 wherein the information specific to the beer keg is based upon said step b).

13) A system for tracking beer kegs comprising:
a computer associating a beer keg with a user link, the computer associating information regarding the beer keg with the user link, the computer configured to receive communications from user-carried electronic devices responsive to the user link and to respond to the communications based upon the information regarding the beer keg.

14) The system of claim 13 wherein the information includes a date that the beer keg was filled.

15) The system of claim 13 wherein the information indicates contents of the beer keg.

16) The system of claim 13 wherein the communications received from the user-carried electronic devices include a current geographic location of the beer keg.

17) The system of claim 13 wherein the user-carried electronic devices are smartphones.

18) The system of claim 13 wherein the user link includes an RF chip or an optical code.
